(19) United States
(12) Patent Application Publication
(10) Pub. No.: US 2004/0238563 A1
(43) Pub. Date: Dec. 2, 2004

(54) Dispensing apparatus for pack of drink

(76) Inventor: Chien-Fu Lin, Taichung (TW)

Correspondence Address: BIRCH STEWART KOLASCH & BIRCH, PO BOX 747, FALLS CHURCH, VA, 22040-0747, US

(21) Appl. No.: 10/449,401

(22) Filed: Jun. 2, 2003

(51) Int. Cl. B67D 5/00

(52) U.S. Cl. 222/81; 222/192

(57) ABSTRACT

A dispensing apparatus includes a dispenser, a cap and a cover. The dispenser includes a mouthpiece for insertion in a mouth, an insert for insertion in a pack of drink and a stop between the mouthpiece and the insert for avoiding insertion of the mouthpiece into the pack. The cap can conceal the insert. The cover can close the mouthpiece.

### Field of Invention

The present invention relates to drinks and, more particularly, to a pack of drink and, more particularly, to a dispensing apparatus for a pack of drink.

### Background of Invention

Drinks are sold in various ways, e.g., in cans, bottles and packs. A pack is typically made of a laminate. The laminate includes a paperboard and an aluminum foil coated on the paperboard.

In a design, no weak point is provided in the pack. A corner must be cut from the pack so as to define an orifice through which drink can be poured. A pair of scissors or a knife is necessary for getting drink from the pack.

In another design, an orifice is punched in the paperboard during production of the pack. A straw with a point is inserted through the orifice in order to pierce the aluminum foil. Thus, drink can be sucked from the pack through the straw. However, this design is not convenient for two persons wanting to share a pack of drink.

Taiwanese Patent Publication No. 333197 discloses a pack of drink. The pack is made of a laminate. The laminate includes a paperboard and an aluminum foil coated on the paperboard. In production of the pack, two corners are cut from the paperboard. Two corners of the aluminum foil extend beyond the chamfered corners of the paperboard. When the pack is made, a corner 12 of a bag made of the aluminum foil is exposed from an orifice It defined in a box made of the paperboard. A person is supposed to remove the corner 12 from the bag without using any tool. Therefore, a balance between the capability of sealing the drink and the easiness of removing the corner 12 without use of a tool is important. However, such a balance often requires a high level of fabrication and therefore entails a high cost.

The applicant's co-pending U.S. patent application Ser. No. 10/287649 filed on Nov. 5, 2002 discloses a dispensing apparatus for a pack of drink believed to obviate or at least alleviate the above-mentioned problems. It however cannot keep drink in the pack after the dispensing apparatus is inserted into the pack.

The present invention is therefore intended to obviate or at least alleviate the problems encountered in prior art.

### SUMMARY OF INVENTION

It is an objective of the present invention to provide a convenient dispensing apparatus for a pack of drink.

It is another objective of the present invention to provide an inexpensive dispensing apparatus for a pack of drink.

It is another objective of the present invention to provide a dispensing apparatus for a pack of drink capable of keeping drink in the pack after the dispensing apparatus is inserted into the pack.

According to the present invention, a dispensing apparatus includes a dispenser, a cap and a cover. The dispenser includes a mouthpiece for insertion in a mouth, an insert for insertion in a pack of drink and a stop between the mouthpiece and the insert for avoiding insertion of the mouthpiece into the pack. The cap can conceal the insert. The cover can close the mouthpiece.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the drawings.

FIG. 1 is a perspective view of a dispensing apparatus for a pack of drink according to a first embodiment of the present invention.

FIG. 2 is an exploded view of the dispensing apparatus of FIG. 1.

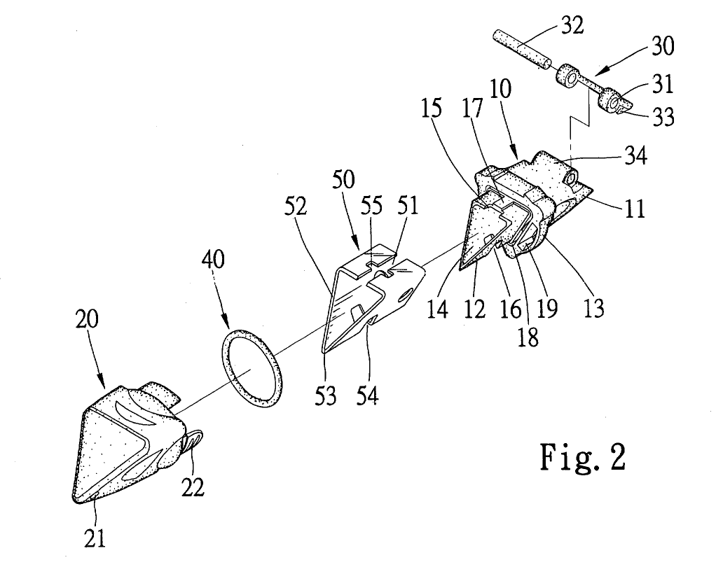

FIG. 3 is a side view of the dispensing apparatus of FIG. 1.

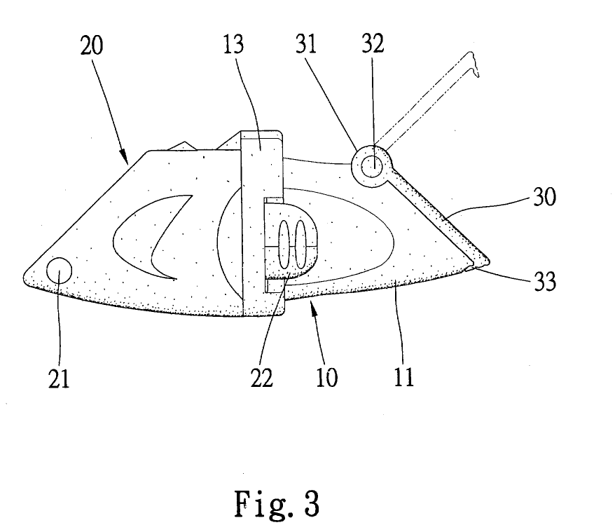

FIG. 4 is a cross-sectional view of the dispensing apparatus of FIG. 1 ready to dispense drink from a pack.

FIG. 5 is a perspective view of a dispensing apparatus for a pack of drink according to a second embodiment of the present invention.

FIG. 6 is a perspective view of a dispensing apparatus for a pack of drink according to a third embodiment of the present invention.

FIG. 7 is an exploded view of the dispensing apparatus of FIG. 6.

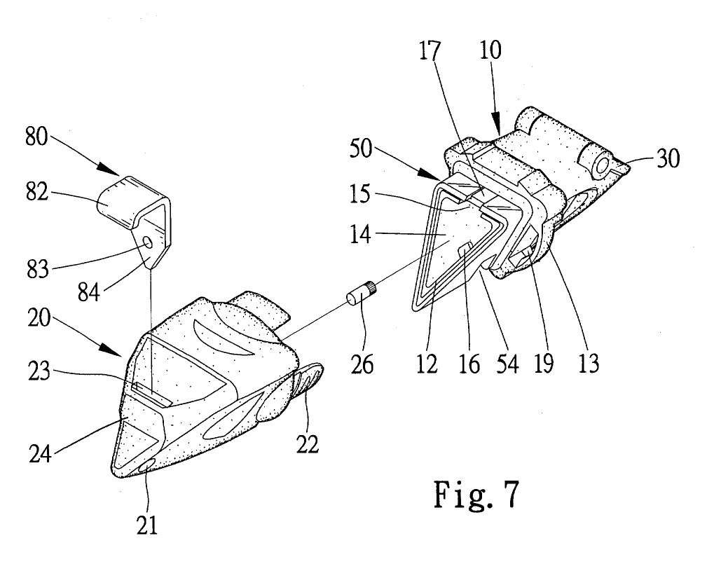

FIG. 8 is a cross-sectional view of the dispensing apparatus of FIG. 6.

FIG. 9 is a side view of the dispensing apparatus of FIG. 6 ready to open a bottle.

FIG. 10 is an exploded view of a dispensing apparatus for a pack of drink according to a fourth embodiment of the present invention.

FIG. 11 is a perspective view of the dispensing apparatus of FIG. 10 attached to a refrigerator by means of magnetic attraction.

### DETAILED DESCRIPTION OF EMBODIMENTS

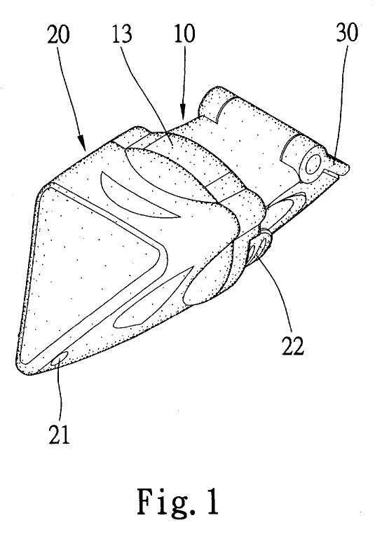

FIGS. 1˜4 show a dispensing apparatus according to a first embodiment of the present invention for a pack 60 of drink. The dispensing apparatus includes a dispenser 10, a cap 20, a cover 30, a ring 40 and a cutter 50.

A passage 14 extends throughout the dispenser 10. The dispenser 10 includes a mouthpiece 11 at an end, an insert 12 at an opposite end and a stop 13 between the mouthpiece 11 and the insert 12. A cutout 15 is defined in an edge of the mouthpiece 11. A slot 16 is defined in the mouthpiece 11. A ridge 17 is formed on the mouthpiece 11. A groove 18 is defined in the stop 13. A slot 19 is defined in the stop 13.

The cover 30 is pivotally attached to the mouthpiece 11 by means of a hinge. The hinge includes a shaft 32, two bearings 31 integrated with the cover 30 for receiving the shaft 32 and a bearing 34 integrated with the mouthpiece 11 for receiving the shaft 32. The cover 30 includes a hook 33 for hooking the mouthpiece 11.

The cutter 50 includes a first edge and a second edge. The first edge is fit in the groove 18 as the cutter 50 is attached to the insert 12. The second edge forms a blade 52 with a point 53 for piercing the pack 60. The cutter 50 defines a slit 51 for receiving the ridge 17 when the cutter 50 is attached to the insert 12. The cutter 50 defines a slot 55 communicated with the cutout 15 when the cutter 50 is attached to the insert 12. The cutter 50 defines a slot 54 communicated with the slot 16 when the cutter 50 is attached to the insert 12.

The ring 40 is mounted on the cutter 50.

The cap 20 defines an aperture 20 through which fluid can flow, and includes a tab 22 extending from an edge thereof. The tab 22 is inserted into the slot 19 when the cap 20 conceals the insert 12.

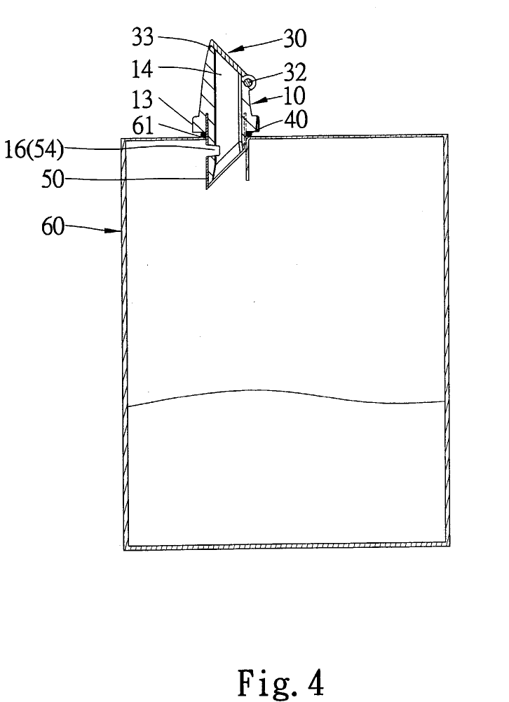

In a working position shown in FIG. 4, the cap 20 is removed from the cutter 50. The cutter 50 is inserted into the pack 60. In the process of insertion, the point 53 starts to pierce an aperture in the pack 60, and the cutting edge 15 enlarges the aperture 41. Thus, drink can be poured from the pack 60 into a cup through the dispenser 10. The stop 13 prevents complete insertion of the dispenser 10 into the pack 60. The ring 40 prevents undesirable leakage of the drink. The slots 16 and 54 allow drink to flow from the pack 60 as much as possible.

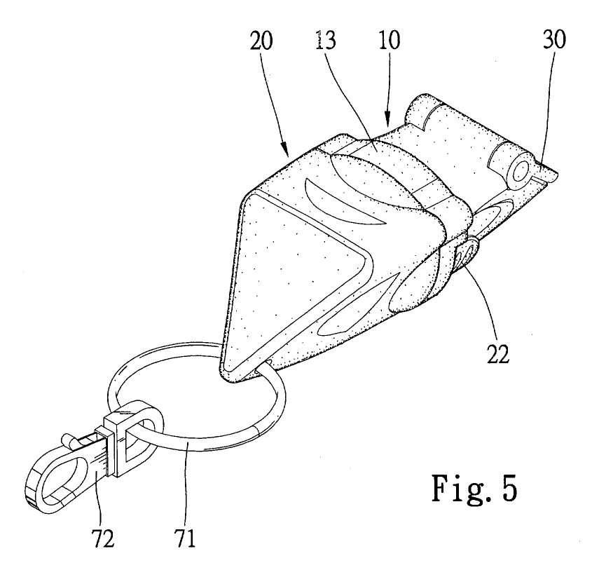

FIG. 5 shows a dispensing apparatus according to a second embodiment of the present invention. The second embodiment is identical to the first embodiment but including a ring 71 connected with the cap 20 and a shackle 72 connected with the ring 71. The ring 71 is in the form of a key ring.

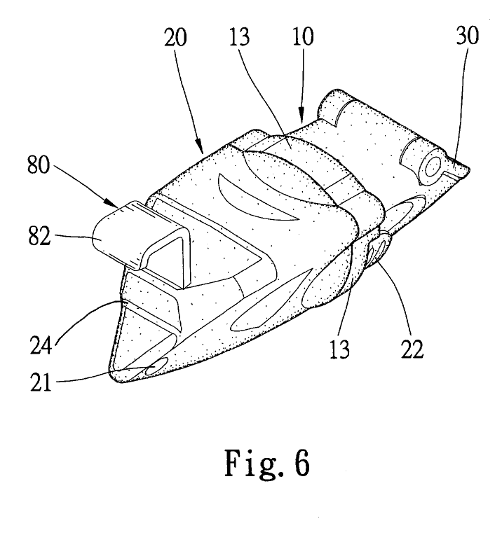

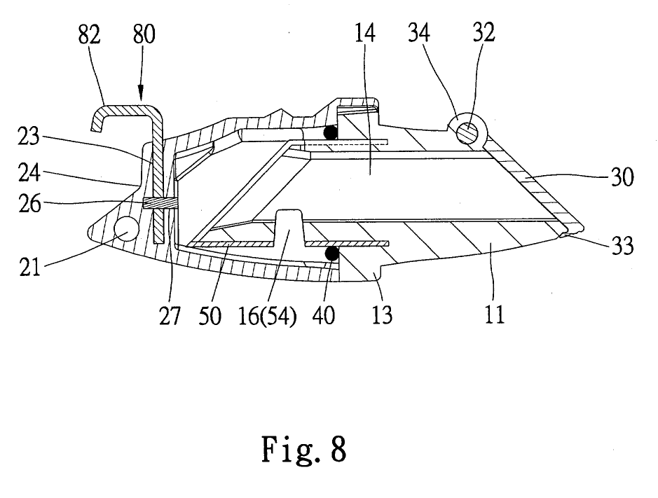

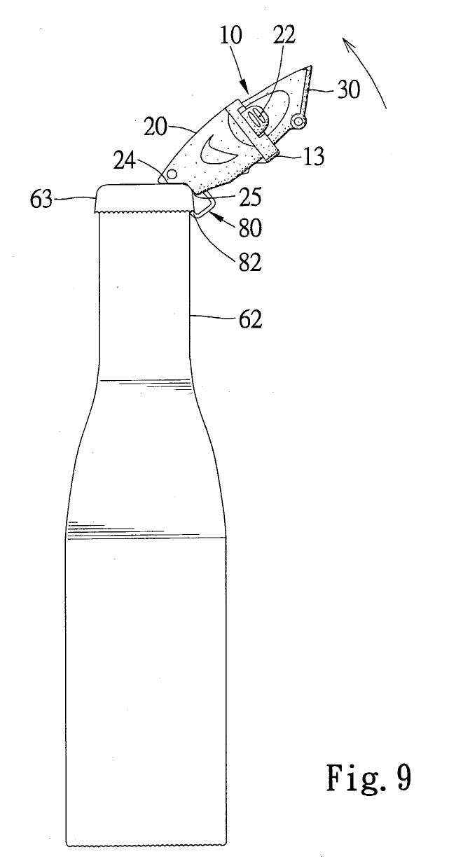

FIGS. 6˜8 show a dispensing apparatus according to a third embodiment of the present invention. The third embodiment is identical to the first embodiment but including a bottle opener 80 attached to the cap 20. The bottle opener 80 includes a hook 82 at an end and an insert 84 at another end. The insert 84 is inserted in a recess 23 defined in the cap 20. As best shown in FIG. 8, a pin 26 is forced into the cap 20 through an aperture 83 defined in the insert 84, thus securing the bottle opener 80 to the cap 20. The cap 20 includes a recessed end 24 for engagement with the cover 63. Referring to FIG. 9, the recessed end 24 is engaged with an appropriate portion of the cover 63, and the hook 82 with an edge of the cover 63. Thus, counterclockwise pivoting of the cap 20 as well as the bottle opener 80 removes the cover 63 from the bottle 62.

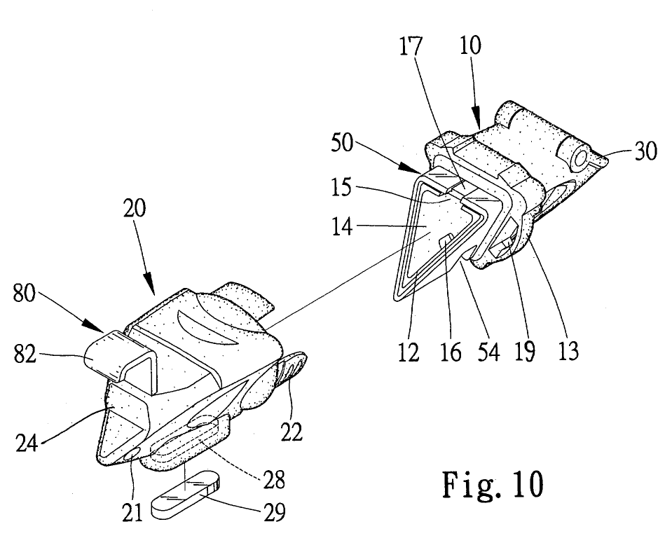

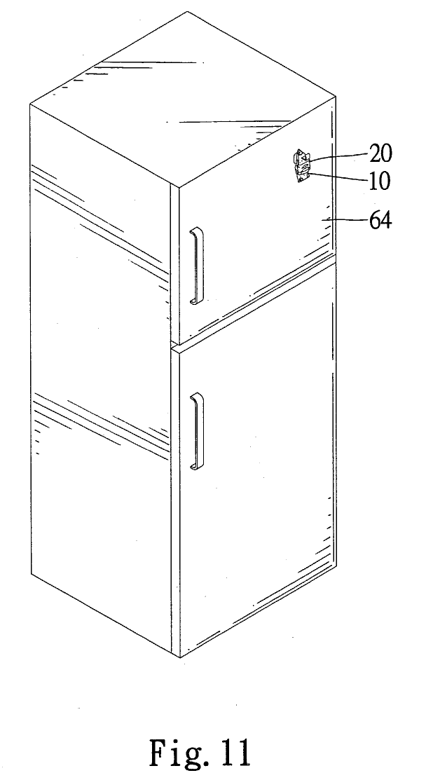

FIG. 10 shows a dispensing apparatus according to a fourth embodiment of the present invention. The fourth embodiment is identical to the third embodiment but including a magnet 29 fit in a recess 28 defined in the cap 20. Referring to FIG. 11, the magnet 29 enables attachment of the dispensing apparatus to a refrigerator 64 via magnetic attraction.

The present invention has been described via detailed illustration of the embodiments. Those skilled in the art can derive many variations from the embodiments without departing from the scope of the present invention. Therefore, the embodiments shall not limit the scope of the present invention as defined in the attached claims.

What is claimed is:

1. A dispensing apparatus including:
a dispenser including a mouthpiece for insertion in a mouth, an insert for insertion in a pack of drink and a stop between the mouthpiece and the insert for avoiding insertion of the mouthpiece into the pack;
a cap for concealing the insert; and
a cover for closing the mouthpiece.

2. The dispensing apparatus according to claim 1 wherein the cover is pivotally connected with the mouthpiece.

3. The dispensing apparatus according to claim 2 including a hinge for pivotally connecting the cover with the mouthpiece.

4. The dispensing apparatus according to claim 3 wherein the hinge includes a shaft, at least one bearing integrated with the cover for receiving the shaft and at least one bearing integrated with the mouthpiece for receiving the shaft.

5. The dispensing apparatus according to claim 2 wherein the cover includes a hook for hooking the mouthpiece.

6. The dispensing apparatus according to claim 1 including a cutter attached to the insert for cutting into the pack.

7. The dispensing apparatus according to claim 6 wherein the cutter includes a blade for cutting into the pack.

8. The dispensing apparatus according to claim 7 wherein the blade includes a point for piercing the pack.

9. The dispensing apparatus according to claim 6 wherein the stop defines a groove for receiving an edge of the cutter.

10. The dispensing apparatus according to claim 6 wherein the stop defines a slot, and the cap includes a tab extending from an end thereof into the slot, thus keeping the cap on the insert.

11. The dispensing apparatus according to claim 1 including a ring connected with the cap and a shackle connected with the ring.

12. The dispensing apparatus according to claim 1 including a bottle opener secured to the cap.

13. The dispensing apparatus according to claim 12 wherein the bottle opener includes a hook for hooking an edge of a cover and an insert secured to the cap.

14. The dispensing apparatus according to claim 13 wherein the insert of the bottle opener is fit in a recess defined in the cap.

15. The dispensing apparatus according to claim 14 including a pin forced into the cap through an aperture defined in the insert of the bottle opener.

16. The dispensing apparatus according to claim 1 including a magnet secured to the cap.
